(19) United States
(12) Patent Application Publication
(10) Pub. No.: US 2006/0026687 A1
(43) Pub. Date: Feb. 2, 2006

(54) Protecting embedded devices with integrated permission control

(76) Inventor: Cyrus Peikari, (US)

Correspondence Address: Cyrus Peikari, 6242 Walnut Hill Ln, Dallas, TX, 75230, US

(21) Appl. No.: 11/181,512

(22) Filed: Jul. 14, 2005

Related U.S. Application Data
(60) Provisional application No. 60/592,927, filed on Jul. 31, 2004.

(51) Int. Cl. G06F 12/14

(52) U.S. Cl. 726/24

(57) ABSTRACT

A system for optimizing the security of embedded, mobile devices such as personal data assistants and Smartphones by controlling the permission level between the upper, user-mode layer and the lower, protected kernel layer. In a preferred embodiment, this is achieved by interposing an integrated driver between upper layers (applications, functions and protected subsystems) and the system kernel; intercepting system calls from upper layers (applications, functions and protected subsystems) and the system kernel using an integrated driver; controlling which user mode applications, functions or protected subsystems have permission to access the protected kernel; optionally scanning for viruses in real time using an integrated driver; optionally scanning for viruses heuristically using the integrated driver; permitting a user-controlled, desired level of protection; or providing automated and/or scheduled feedback to the operating system, to a user and/or to external files regarding the security of the system that may include the operation of the embedded driver.

### REFERENCES

Applicant claims the benefit of Provisional Patent Application No. 60/592,927 with filing date Jul. 31, 2004.

### STATEMENT REGARDING FEDERALLY SPONSORED RESEARCH OR DEVELOPMENT

Not Applicable

### FIELD OF THE INVENTION

The invention relates to the protection of data processing systems. In particular, the invention is directed to increasing the security of embedded computing devices, especially by protecting against malicious code such as computer viruses, worms and Trojan horses that cause data corruption and data loss.

### BACKGROUND OF THE INVENTION

Computer processing systems (such as desktop computers and computer networks) are vulnerable to malicious code and programs such as computer viruses, worms and Trojan horses. A common method of protection against malicious code involves using protection programs such as a virus scanner. For example, the most common form of virus scanner operates by pattern matching, which involves scanning data in binary files for unique strings or signatures of unique byte sequences.

Embedded, wireless devices such as personal data assistants (PDAs) and advanced mobile phones (smartphones) are becoming increasingly prevalent. In fact, embedded operating systems are beginning to allow even miniature devices such as watches and toasters to run advanced software and to communicate using wireless radio frequency (RF). Like their desktop computing counterparts, these tiny devices are also vulnerable to malicious programming code such as computer viruses. In fact, the first viruses and Trojans for smartphones and PDAs have already appeared.

Embedded platforms such as Windows CE power handheld devices such as Windows® Mobile Smartphone and Pocket PC. Unfortunately, the Windows CE platform, because of its special embedded design, has unique security vulnerabilities. Smartphones and PDAs that run the Windows CE operating system are particularly vulnerable to new types of attack.

One of class of newly discovered attack allows malicious code such as viruses to attack and destroy data on the device. The problem stems from vulnerability in the Windows CE operating system design. For example, in the current Windows Mobile 2003 operating system (Windows CE 4.2), the platform is designed with a protected kernel. The kernel is the heart of the operating system; most important functions reside here. In order to protect the important processes in the kernel, Windows CE is designed with a “protected” kernel. In other words, user-mode applications (like graphical games) that run at upper layers of the operating system are prevented from interfering with or “crashing” the protected kernel on top of which it runs.

At least, the kernel is protected in theory. In reality, it was recently discovered that there is at least one major flaw in the implementation of the protected kernel. For example, the first virus (Dust) has recently appeared that infects Windows CE handheld devices. For the past four years, it was generally thought that Windows CE was safe from viruses and other malware because of its protected kernel. However, Dust was able to infect Pocket PC devices that run Windows CE. Dust can even be easily modified to crash the handheld device and totally erase all of the user's data by forcing a “hard” factory-level reset. This devastating attack is possible because there is a flaw in implementation of the protected kernel design.

Dust exploited a new vulnerability that gave it access to the protected kernel. Normally, applications such as viruses are not able to gain an entry-point to infect another program. This is because in order to infect another file, a virus must have access to the “Coredll module”. According to the manufacturer, the Coredll module is the basic operating system (OS) module that provides core functionality to other modules. Without access to Coredll, infecting another file is impossible. Coredll is supposed to be protected from usermode applications since it resides in the kernel. However, there is at least one loophole. For example, the function KDataStruct is placed at a hardcoded address accessible from user mode. Using the KdataStruct function, the Dust virus was able to gain an entry point to Coredll, which thus allowed it to infect other files. Microsoft's protected kernel had been broken, and Windows Mobile devices were now totally vulnerable.

Because this is an entirely new class of vulnerability, prior art systems have no defense whatsoever against this devastating kind of attack. In order to overcome this limitation of the prior art, the current invention incorporates a unique driver integrated between the various layers of the operating system (e.g., interposed between usermode and kernel mode). The unique driver intercepts system calls from upper layers (applications and protected subsystems) and the system kernel. The integrated driver can, for example, scan for viruses in real time using an embedded driver, using either standard signature-based virus scanning or through behavior-based virus scanning (heuristics).

In a second embodiment, the user has the option to decide what level of protection (e.g., low, medium or high security) is allowed when protecting the kernel. The higher the level of optional protection, the stricter the permission rules (e.g., heuristic blocking features) are.

In a third embodiment, the system includes automated and/or scheduled feedback to the operating system, to the user and/or to external files regarding the security of the system that may include the operation of the embedded driver.

### SUMMARY OF THE INVENTION

The present invention overcomes the disadvantages of the prior art, by offering the following:

A method and apparatus for protecting against malicious code such as computer viruses, worms and Trojan horses on embedded devices. The method and apparatus have the following embodiments which may be used alone or in various combinations: interposing an “integrated driver” between upper layers (applications, functions and protected subsystems) and the system kernel; intercepting system calls from upper layers (applications, functions and protected subsystems) and the system kernel using an integrated driver; controlling which user mode applications, functions or protected subsystems have permission to access the protected kernel; optionally scanning for viruses in real time using an integrated driver; optionally scanning for viruses heuristically using the integrated driver; permitting a user-controlled, desired level of protection; or providing automated and/or scheduled feedback to the operating system, to a user and/or to external files regarding the security of the system that may include the operation of the embedded driver.

Because of its unique operation between the upper layers and the system kernel, the above system is fully compatible and may be combined with a variety of prior art protection schemes to add even further protection.

### BRIEF DESCRIPTION OF THE DRAWING

The present invention may be understood more clearly from the following detailed description, which is solely for explanation and should not be taken to limit the invention to any specific form thereof, taken together with the accompanying drawing, wherein:

FIG. 1 illustrates the preferred embodiment of the present invention, wherein the present invention interposes an “integrated driver” between the upper “user mode layer” and the lower, protected system kernel. The integrated driver controls permissions and the flow of information between upper and lower layers, thus preventing vulnerabilities.

### DETAILED DESCRIPTION OF THE INVENTION

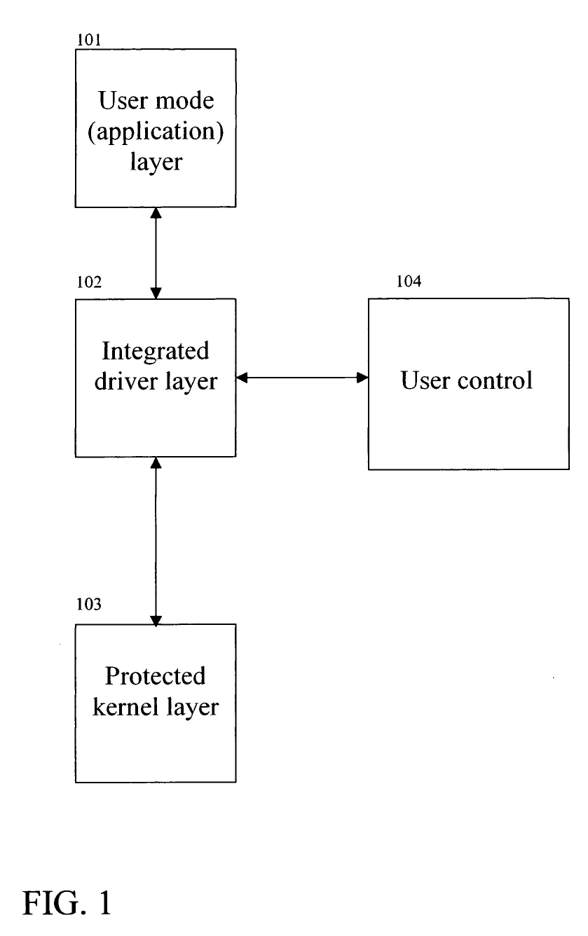

The operation of the present invention will now be described in conjunction with the Drawing Figure. FIG. 1 illustrates the preferred embodiment of the present invention. At step 102, the present invention interposes an “integrated driver” between the upper between the upper “user mode layer” at step 101 and the lower, protected system kernel at step 103. The integrated driver at step 102 controls permissions and the flow of information between upper layers (101) and lower layers (103).

The integrated driver at step 102 also intercepts all system calls between upper layers (101) and lower layers (103), thus preventing vulnerabilities from passing to the protected kernel at 103, thus preventing vulnerabilities from passing to the protected kernel at 103. The integrated driver at step 102 can optionally scan for viruses passing between step 101 and step 102, in real time, using either signature based scanning or heuristic scanning.

A user control at step 104 also allows the user to set a desired level of protection for the integrated driver at step 102. This allows the user at step 104 to set “permission level” for the entire system by controlling the security level at step 102.

The integrated driver at step 102 can also provide automated and/or scheduled feedback to the operating system at step 103, or to a user and/or to external files at the user mode layer (101). This feedback can include information regarding the security of the system that may include the operation of the embedded driver.

1. A method for protecting a data processing system against malicious code, comprising the steps of:
a) interposing an integrated driver between upper layers and a system kernel;
b) intercepting system calls from said upper layers and said system kernel using said integrated driver;
c) controlling which user mode applications, functions or protected subsystems have permission to access said system kernel;
d) optionally scanning for viruses in real time using said integrated driver;
e) optionally scanning for viruses heuristically using said integrated driver;
f) permitting a user-selected level of protection; and
g) providing automated scheduled feedback to an operating system, to a user and to external files regarding the security of the system that include the operation of said integrated driver.

2. An apparatus for protecting a data processing system against malicious code, comprising:
a) means for interposing an integrated driver between upper layers and a system kernel;
b) means for intercepting system calls from said upper layers and said system kernel using said integrated driver;
c) means for controlling which user mode applications, functions or protected subsystems have permission to access said system kernel;
d) means for optionally scanning for viruses in real time using said integrated driver;
e) means for optionally scanning for viruses heuristically using said integrated driver;
f) means for permitting a user-selected level of protection; and
g) means for providing automated and/or scheduled feedback to the operating system, to a user and/or to external files regarding the security of the system that may include the operation of said integrated driver.

3. A method for protecting a data processing system against malicious code, comprising the steps of:
a) interposing an integrated driver between upper layers and a system kernel;
b) intercepting system calls from said upper layers and said system kernel using said integrated driver.

4. The method of claim 3, further comprising the step of:
c) controlling which user mode applications, functions or protected subsystems have permission to access said system kernel.

5. The method of claim 4, further comprising the step of:
d) optionally scanning for viruses in real time using said integrated driver.

6. The method of claim 5, further comprising the step of
e) permitting a user-selected level of protection.

7. The method of claim 6, further comprising
g) providing automated or scheduled feedback to an operating system or to a user or to external files regarding the security of the system that may include the operation of said integrated driver.

8. The method of claim 4, further comprising the step of:
d) optionally scanning for viruses heuristically using said integrated driver.

9. The method of claim 8, further comprising the step of:
e) permitting a user-selected level of protection.

10. The method of claim 9, further comprising the step of:
g) providing automated or scheduled feedback to an operating system or to a user or to external files regarding the security of the system that may include the operation of said integrated driver.

11. The method of claim 3, further comprising the step of:
c) providing automated or scheduled feedback to an operating system or to a user or to external files regarding the security of the system that may include the operation of said integrated driver.

12. The method of claim 3, further comprising the step of:
c) optionally scanning for viruses in real time using said integrated driver.

13. The method of claim 3, further comprising the step of:
c) optionally scanning for viruses heuristically using said integrated driver.

14. The method of claim 4, further comprising the step of
d) permitting a user-selected level of protection.

15. The method of claim 4, further comprising
d) providing automated or scheduled feedback to an operating system or to a user or to external files regarding the security of the system that may include the operation of said integrated driver.
